(19) United States
(12) Patent Application Publication
(10) Pub. No.: US 2011/0165056 A1
(43) Pub. Date: Jul. 7, 2011

(54) METHOD AND SYSTEM FOR PROCESSING GASEOUS EFFLUENTS FOR INDEPENDENTLY PRODUCING H2 AND CO

(75) Inventor: Raymond Guyomarc'h, Saint Theodorit (FR)

(73) Assignee: BIO 3D APPLICATIONS, Paris (FR)

(21) Appl. No.: 12/664,211

(22) PCT Filed: Jun. 16, 2008
(86) PCT No.: PCT/FR2008/051072

§ 371 Date: Jun. 4, 2010

(30) Foreign Application Priority Data
Jun. 15, 2007 (FR) 0704304

(51) Int. Cl. C01B 31/18; B01J 8/00

(52) U.S. Cl. 423/418.2; 422/600

(57) ABSTRACT

A method for the treatment of a first gaseous effluent including carbon dioxide and of a second gaseous effluent including steam, the method includes the following stages: generation of a first gas stream having carbon monoxide by passing the first gaseous effluent through a first layer of redox reactive material including high-temperature carbon components; generation of a second gas stream essentially including dihydrogen by passing the second gaseous effluent through a second redox layer of reactive material including high-temperature carbon components; and utilization of at least one of the first and second gas streams; at least some of the second redox layer being provided by transfer or recovery of at least some of the high-temperature carbon components of the first layer.

The present invention relates to a method for the treatment of gaseous effluents. It also relates to a system employing the method according to the invention.

The field of the invention is the field of treatment of gaseous effluents. More particularly the invention relates to the production of molecules of carbon monoxide (CO) and of hydrogen (H₂) in continuous, independent, concomitant and controlled flows, from a fuel containing carbon components, in particular plant biomass, and gaseous effluents. The invention can be applied in the vast majority of industrial fields.

There are at present methods and systems for the production of carbon monoxide (CO) and hydrogen (H₂) by thermochemical reaction of plant biomass, such as the methods of biomass gasification. These methods enable biomass gasification to be carried out by treatment of the biomass with a hot, moist gas stream in a treatment reactor. The biomass in the reactor is pyrolysed and gasified and the gas stream recovered after biomass gasification is laden with gaseous components such as hydrogen, carbon monoxide and hydrocarbon compounds that are formed during biomass gasification. These gaseous components are all mixed together and it is then necessary to separate them if they are to be exploited separately. A drawback of the gasification methods is that it is not possible to control separately the proportions of the gaseous components present in the gas stream recovered after treatment. Thus, for example, it is not possible to control the proportions of hydrogen and of carbon monoxide produced by biomass gasification. Moreover, these methods only allow the production of mixtures of hydrogen and carbon monoxide. Furthermore, the methods and systems for gasification known at present do not permit treatment of a gaseous effluent containing CO₂, originating from a source other than that of the method itself.

One purpose of the invention is to propose a method and a system for the production of H₂ and of CO that enable the drawbacks of the systems of the state of the art to be overcome.

Another purpose of the invention is to propose a method and a system for the production of H₂ and of CO separately.

Another purpose of the invention is to propose a method and system for the production of H₂ and of CO making it possible to control the amount of H₂ produced independently of the amount of CO produced.

The invention thus proposes a method for the treatment of a first gaseous effluent essentially comprising carbon dioxide (CO₂) and of a second gaseous effluent essentially comprising steam (H₂O), said method comprising the following stages:
generation of a first gas stream comprising carbon monoxide (CO) by passing said first gaseous effluent through a first layer of redox reactive material comprising high-temperature carbon components,
generation of a second gas stream essentially comprising dihydrogen (H₂) by passing said second gaseous effluent through a second redox layer of reactive material comprising high-temperature carbon components, and
utilization of at least one of the first and second gas streams.

Thus, the method according to the invention makes it possible to produce hydrogen and carbon monoxide separately. With the method according to the invention, the proportions of hydrogen produced and of carbon monoxide produced can be controlled separately. Moreover, the carbon monoxide and the hydrogen are not mixed and form two separate gas streams that can be utilized separately. Hereinafter we shall use chemical formulae for easier reading.

The method according to the invention comprises, during passage of the first gaseous effluent containing essentially CO₂ through the first layer containing high-temperature carbon components:
reduction of the molecules of CO₂ in the presence of the high-temperature carbon components. This reduction produces molecules of carbon monoxide (CO); and
oxidation of at least some of the high-temperature carbon components. This oxidation produces molecules of CO.

Thus, the first gas stream obtained from the first gaseous effluent essentially comprises molecules of CO. According to the demonstration described by the physicist BOUDOUARD concerning the equilibria of the oxides of carbon CO₂ and CO, this first gas stream ought only to contain molecules of CO.

Advantageously, the method according to the invention can comprise heat exchange of at least one of the first and second gas streams with a heat-transfer stream, this gas stream giving up at least some of its thermal energy to the heat-transfer stream. In particular the first and the second gas streams can give up at least some of their thermal energy to the heat-transfer stream.

Moreover, the heat-transfer stream can comprise water. In a particular embodiment of the invention the heat-transfer stream can be water in the gaseous or liquid state. Heat exchange of the water with the first and the second gas streams then produces a third gas stream comprising high-temperature steam.

Advantageously, at least some of the steam contained in the second gaseous effluent can come from the third gas stream containing essentially steam. In fact, some of the second gaseous effluent can come from an installation producing a gaseous effluent containing steam. Some of the third gas stream can be mixed with the gaseous effluent coming from this installation to obtain the second gaseous effluent.

In a particular embodiment of the invention, the method can be started with a second gaseous effluent containing water produced by another device, system or installation, which may or may not require an energy input. Once the method is started, the third gas stream can be the second gaseous effluent so that the second gaseous effluent is produced entirely by the method according to the invention, and the method according to the invention is then self-sufficient in thermal energy for producing the second gaseous effluent.

The method according to the invention comprises, moreover, during passage of the second gaseous effluent, containing essentially steam (H₂O), through the second layer containing high-temperature carbon components:
reduction of molecules of steam in the presence of said high-temperature carbon components, said reduction producing molecules of H₂, and
oxidation of at least some of said high-temperature carbon components, said oxidation producing molecules of CO;
reduction of molecules of steam (H₂O) in the presence of the molecules of CO, in a final passage through the second layer and in the zone after the layer of reactive material, in a “CO Shift” reaction producing molecules of H₂, and
oxidation of at least some of said molecules of CO, said oxidation producing molecules of CO₂; the second gas stream essentially comprising hydrogen H₂ and carbon dioxide CO₂.

The method according to the invention can moreover comprise a stage of separation of the CO₂ contained in the second gas stream, to supply a fourth gas stream essentially comprising CO₂ and a fifth gas stream containing essentially hydrogen H₂.

Advantageously, at least some of the fourth gas stream containing essentially CO₂ can be mixed with the first gaseous effluent. In fact, some of the first gaseous effluent can come from an installation producing a gaseous effluent containing CO₂. Some of the fourth gas stream can be mixed with the gaseous effluent coming from this installation to obtain the first gaseous effluent.

In a particular embodiment of the invention, the method can be started with a first gaseous effluent containing CO₂ produced by another device, system or installation, which may or may not require an energy input. Once the method is started, the fourth gas stream can be the first gaseous effluent so that the first gaseous effluent is produced entirely by the method according to the invention, and the method according to the invention is self-sufficient for generating the first gaseous effluent.

Moreover, at least some of the first redox layer is produced by combustion, in the presence of a supporter of combustion, of a fuel composed of carbon components under substoichiometric conditions.

This solid fuel can comprise plant biomass. In fact, plant biomass complies advantageously with the criterion of solid fuel composed of carbon. Moreover, plant biomass contributes to the natural carbon cycle as follows. The carbon contained in the atomic composition of plant biomass comes from the transformation, essentially by photosynthesis, of atmospheric carbon dioxide. It is therefore considered that the CO₂ arising from the combustion of plant biomass has a neutral effect on the greenhouse gas problem, in contrast to that arising from the combustion of fossil fuels. Moreover, plant biomass is a renewable energy source. The CO₂ and hydrocarbon molecules form part of the eco-cycle of life, and industry generates these molecules in excess, thus creating a deep imbalance, which pollutes the ecosystem. These components can be recycled directly by the method in a permanent fashion, and therefore will no longer add to greenhouse gases (GHGs). Moreover, the great majority of the sources of plant biomass, which is a renewable raw material that can be cultivated, can be used by the method according to the invention. Their utilization and impact on the environment is beneficial when they are processed for the use of the method:
simply shredded in sheets or coarse chips, forest biomass will be optimized by dehydration, which permits exhaustive exploitation of its energetic power,
by roasting these chips, by an appropriate technique that recycles the energy that is employed therein, its proportion of carbon per weight of final material is increased considerably, thus making the fuel more reactive,
ground, dried and densified, all plant biomass will be transformed to a solid fuel that is homogeneous, stable and sized, and that possesses identical properties, whatever the origin of the raw materials, whether from forestry and/or agriculture. High-performance densification concentrates the carbon of the plant material to 85% of the mass (instead of 50% of the source material) and the product from this technique can advantageously be of cylindrical shape, to promote flow by gravity in the system.

Roasting and/or densification improve the overall exploitation of the system due notably to the maintaining of the quality of the solid fuel during storage.

Plant biomass is available practically everywhere and in abundance, and its densification can be carried out at the actual site of exploitation, such as at the site of an industrial concern that installs the system implementing the method according to the invention.

The combustion of the solid fuel can be carried out with O₂ as supporter of combustion. This supporter of combustion can be supplied by targeted injection into the middle of the first layer.

Advantageously, at least some of the second redox layer is provided by transfer or recovery of at least some of the high-temperature carbon components of the first layer. The first layer can be located above the second layer. Moreover the first layer can be inclined towards the second layer so that at least some of the high-temperature carbon components of the first layer flow by gravity from the first layer to the second layer.

According to the invention, the temperature of the first layer is greater than or equal to 1000° C. and the temperature of the second layer is between 800 and 1000° C. The temperatures of the first layer and of the second layer can be adjusted by injection of a supporter of combustion, for example O₂.

As mentioned above, the method according to the invention can comprise separation of the molecules of CO₂ and H₂ present in the second gas stream, this separation supplying a fifth gas stream essentially comprising H₂. The CO₂ is recyclable to CO by the first layer, can be stored temporarily, as liquid and/or gas, for use in the control and safety of the installation. It can also be marketed, in liquid form, to industrial users. The deoxidation of this CO₂ to 2 CO also permits withdrawal of CO, which can be compensated for by supplying CO₂ of industrial origin, which is itself then withdrawn from the greenhouse gases at the time of a new life cycle or definitively if replacing fossil fuels.

Advantageously, the method according to the invention can comprise synthesis of hydrocarbon compounds from H₂ and CO in means such as catalysers.

In fact, the method according to the invention can provide three separate gas streams containing CO, H₂ and CO₂, which can be stored in buffer tanks, to be used, in any desired proportions, in all existing and future hydrocarbon formulations, in the eco-industrial area of chemistry and petrochemistry, as well as the environment and pollution control.

More particularly, the invention is aimed at the production of synthesized liquid and gaseous fuels and supporters of combustion, so that petroleum products and natural gas can be replaced with these fuels and supporters of combustion that are derived from plants and are renewable. For the synthesis of these fuels and supporters of combustion, CO and H₂ molecules are used. These two gases are directed, according to the required quantities and at the appropriate temperature for the particular synthesis, to the dedicated catalytic system. The purified gases can advantageously be heated by the reaction gases, before they are cooled to the purification temperature. The thermal cycle thus defined is in a loop, without losses other than those inherent in the losses of any thermal plant or system. The energetic power of the hydrocarbon compounds, before the catalytic synthesis, is the maximum of the energy potential of the fuel employed in the system according to the invention that could be obtained.

At the catalyser outlet, the novel synthesized energy source is recovered:
the synthesized biogas is prepared for storage and/or used as it is,
the liquid hydrocarbons are distilled for storage as they are and used,
the hydrocarbon compounds, for the production of substitution energy or synthesized molecules, are prepared for storage as they are and/or used.

Moreover, the method according to the invention purifies at least one of the first and second gaseous effluents by combustion of combustible particles present in the first gaseous effluent and/or in the second gaseous effluent during passage of these gaseous effluents through the first layer and/or the second layer.

According to another aspect of the invention, a system is proposed for recycling a first gaseous effluent essentially comprising (CO₂) and a second gaseous effluent essentially comprising steam (H₂O). The system according to the invention comprises an enclosure comprising:
a first reactor comprising a first grate supporting a first redox layer of reactive material comprising high-temperature carbon components, the first layer being traversed by the first gaseous effluent supplying a first gas stream comprising CO, and
a second reactor comprising a second grate supporting a second redox layer of reactive material comprising high-temperature carbon components, the second layer being traversed by the second gaseous effluent supplying a second gas stream comprising H₂.
   The system according to the invention further comprises means for utilization of at least one of the first and second gas streams.

Advantageously, the system according to the invention can comprise a communicating opening through which the first and second reactors communicate with one another so that at least some of the high-temperature carbon components of the first layer pass from the first reactor to the second reactor through the communicating opening to form at least some of the second layer.

Moreover, the first grate supporting the first layer is located higher than the second grate supporting the second layer. The first grate is inclined appreciably towards the second grate, the lowest end of the first grate being located at the level of the communicating opening so that at least some of the high-temperature carbon components of the first layer flow from the first reactor to the second reactor to form the second layer. This design avoids the endothermic phase of this second layer of reactive material (if it were to be supplied with cold solid fuel) which would generate oxides of carbon, which might disturb the generation of the second gas stream.

Furthermore, the first and second grates are permeable to the first or second gas stream, and each of these grates separates the reactor in which it is located into a first zone and a second zone. The first zone is located above the grate and comprises an opening for feeding the gaseous effluent into the reactor and the second zone is located below said grate and comprises an opening for extraction of the gas stream. Moreover, these grates can be cooled by means of a heat-transfer fluid, which can be water, circulating in or sprayed onto these grates.

Advantageously, the first reactor can comprise a feed opening, on the first grate, for a fuel comprising carbon components, the first layer being produced by combustion of the fuel under substoichiometric conditions in the presence of a supporter of combustion. This fuel is preferably plant biomass.

Each of the first and second reactors can in addition comprise means for the injection of a supporter of combustion into the reactor and more particularly into the middle of the first layer of redox reactive material. This supporter of combustion is used on the one hand for combustion, under substoichiometric conditions, of the fuel fed into the first reactor and consequently of that fed by gravity through the feed opening into the second reactor and, on the other hand, for regulating the temperature of the two layers of redox reactive materials.

The system according to the invention can moreover comprise means for the recovery of residues coming from each of the first and second reactors. These residues can be discharged from each of the reactors via a discharge opening located in the bottom of the reactor and opening into at least one ash box provided for collecting the residues.

The system according to the invention can moreover comprise at least one heat exchanger providing heat exchange of at least one of said first and second streams with a heat-transfer fluid.

This heat-transfer fluid can be water. The heat exchanger then supplies a third gas stream essentially comprising high-temperature steam. The system according to the invention can moreover comprise a circuit for conveying at least some of the third gas stream into the second reactor or into the second gaseous effluent.

Furthermore, the system according to the invention can comprise means for separating the various gaseous compounds of the second gas stream, comprising H₂ and CO₂, obtained by oxidation-reduction of steam in the presence of high-temperature carbon components. These separating means can supply a fourth gas stream essentially comprising CO₂ and a fifth gas stream essentially comprising H₂.

At least some of the fourth gas stream can be conveyed into the first reactor or mixed in the first gaseous effluent by means of a conveying circuit.

Finally, the system according to the invention can comprise means for synthesis of hydrocarbon compounds from H₂, CO but also CO₂ obtained during the method according to the invention.

Other advantages and characteristics will become apparent on examination of the detailed description of an embodiment, which is in no way limitative, and the attached diagrams in which:

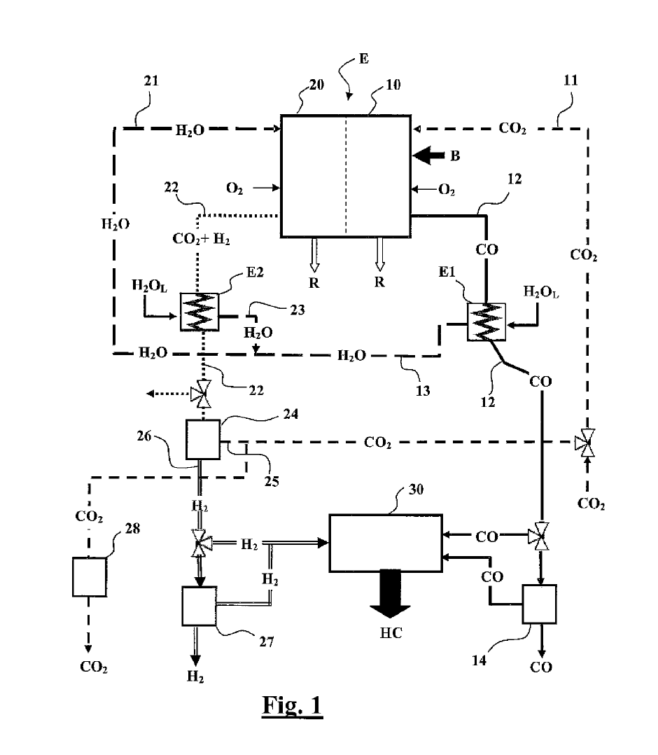

FIG. 1 is a diagrammatic representation of the system according to the invention; and

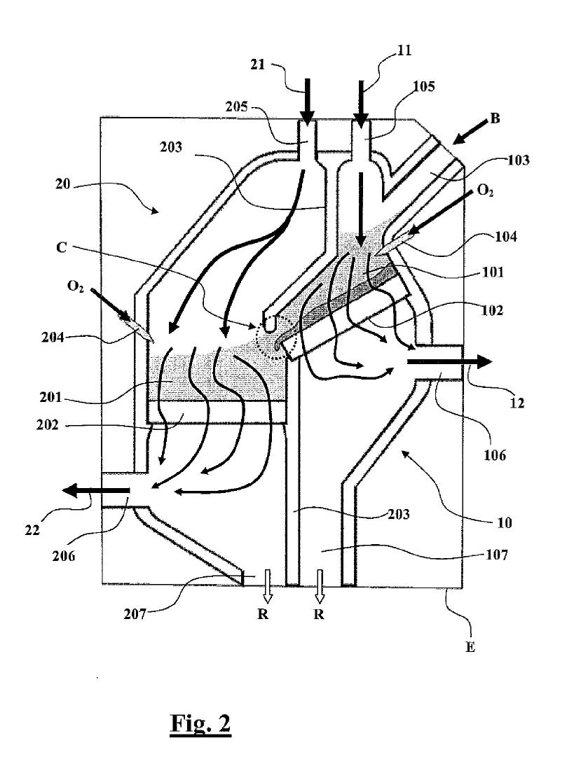

FIG. 2 is a diagrammatic representation of an enclosure according to the invention comprising the first reactor and the second reactor.

FIG. 1 is a diagrammatic representation of the system according to the invention.

The system according to the invention comprises an enclosure E comprising a first reactor 10 comprising a first redox layer of reactive material comprising high-temperature carbon components and a second reactor 20 comprising a second redox layer of reactive material comprising high-temperature carbon components. This reaction enclosure E, comprising the two reactors 10 and 20, is shown in FIG. 2 and is described in detail below.

Reactor 10 in the enclosure E receives biomass B as feed for the reactions taking place in reactors 10 and 20 and more particularly for forming the redox layers in reactors 10 and 20. The biomass B is preferably plant biomass whose calorific value has been optimized. The biomass B fed into the first reactor 10 undergoes oxycombustion under substoichiometric conditions in the presence of a supporter of combustion which is O₂. Oxygen is injected directly into reactor 10 and optionally into reactor 20, on the one hand for combustion of the biomass B and, on the other hand, to control the temperatures of the layers of reactive material in reactors 10 and 20. The oxygen can be industrial oxygen.

Reactor 10 receives a first gaseous effluent 11 essentially comprising carbon dioxide CO₂. This gaseous effluent 11 can come, at least partly, from an external installation. In the example shown in FIG. 1 the gaseous effluent 11 is produced by recycling the various gas streams produced by the system according to the invention at different stages of the method according to the invention. On passing through the layer of reactive material in reactor 10, composed of solid carbon-containing fuel in substoichiometric oxycombustion, the CO₂ present in the first gaseous effluent 11 and that originating from the combustion of the biomass are reduced to carbon monoxide CO, according to the reaction defined by Boudouard:

CO₂+C 2CO.

Conversion is total once the reaction temperature is greater than or equal to 1000° C. CO is an industrial gas; it is the active form of carbon entering the synthesis catalysers. Moreover, the CO obtained can contribute to the synthesis of carbon-containing materials for use in hydrocarbon molecules and for producing industrial products. The life cycle of CO₂, present in the first gaseous effluent 11 and arising from combustion of the biomass B in the supporter of combustion O₂, is thus prolonged and replaces its equivalent in fossil carbon that would have contributed to greenhouse gases. Reactor 10 supplies, at its outlet, a first gas stream 12 essentially comprising CO.

For its part, reactor 20 receives a second gaseous effluent 21 essentially comprising high-temperature steam H₂O. This second gaseous effluent 21 can come, at least partly, from an external installation. In the example shown in FIG. 1 the second gaseous effluent 21 is produced by energy utilization of the various gas streams produced by the system according to the invention at different stages of the method according to the invention. The steam H₂O in the second gaseous effluent 21 is at very high temperature, acquired by cooling the gases leaving the two reactors. The temperature of the steam that passes through the dedicated reactor of reaction enclosure 1 must be between 700 and 1000° C. to be in the conditions required for the deoxidation reaction. On passing through the layer of reactive material, in reactor 20, comprising carbon components at high temperature, greater than or equal to 1000° C., the H₂O molecule will lose its oxygen atom to a carbon atom and/or to a molecule of CO (carbon monoxide) according to the formula:

C+H₂O→CO+H₂,

then

CO+H₂O→CO₂+H₂,

Reactor 20 supplies, at its outlet, a second gas stream 22 essentially comprising dihydrogen H₂ and carbon dioxide CO₂.

At the outlet of enclosure E and more particularly of the first and second reactors 10 and 20, the first and second gas streams 12 and 22 are at high temperature. They are difficult to utilize at this temperature. Their heat load is useful for the reaction process. It is therefore best to recover them.

The first gas stream 12 produced by reactor 10 passes through a water/gas exchanger E1. In the heat exchanger E1 the first gas stream 12 comprising carbon monoxide CO will transfer its excess heat to a heat-transfer fluid, which in the example shown in FIG. 1 is liquid water H₂O_{L}. This heat-transfer fluid is at the temperature and pressure of the distribution mains or of a dedicated storage tank. On exchanging its heat load, the first gas stream 12 will evaporate the water and supply a third gas stream 13 essentially comprising high-temperature steam. The cooling of the first gas stream 12 is defined by the instruction for storage of the carbon monoxide CO, in the first gas stream 12, in a tank 14 and/or the instruction for use of this CO. This temperature can be close to the temperature of the liquid water H₂O_{L} entering exchanger E1. The superheated steam making up the third gas stream 13 leaving exchanger E1 is conveyed to reactor 20 to be deoxidized there, as described above. The heat capacity of the first gas stream 12 is thus fully recycled and contributes to the overall efficiency of the method according to the invention. Thus, the third gas stream partly makes up the second gaseous effluent 21.

The second gas stream 22 produced by reactor 20 passes into an exchanger E2 similar to exchanger E1, i.e. a water/gas heat exchanger, in which the second gas stream 22, essentially comprising H₂ and CO₂ according to the approximate respective proportions of ⅔-⅓, will transfer its excess heat to a heat-transfer fluid which, in the example shown in FIG. 1, is also liquid water H₂O_{L}. This heat-transfer fluid is at the temperature and pressure of the distribution mains or of a dedicated storage tank. On exchanging its heat load, the second gas stream 22 will evaporate the liquid water H₂O_{L}. At the outlet of exchanger E2 we therefore have a gas stream 23 essentially comprising superheated steam which is mixed with the third gas stream 13 to be returned to reactor 20, where it is deoxidized. The whole (gas stream 13+gas stream 23) supplied by heat exchangers E1 and E2 makes up the second gaseous effluent 21. The cooling of the second gas stream 22 is defined by the instruction for use and/or storage of the second gas stream 22, and/or the temperature that is suitable for better efficiency of a gas separator 24 which separates the dihydrogen H₂ and carbon dioxide CO₂, a temperature that can be close to the temperature of the liquid water entering exchanger E2.

The recovery and recycling of the heat capacities of the first and second gas streams 12 and 22 contribute to the overall efficiency of the system according to the invention and notably to the transfer of energy from the solid biomass to the “gas-energy” molecules H₂ and CO.

The separator 24 separates the H₂ and CO₂. At the outlet of separator 24 we therefore have a fourth gas stream 25 essentially comprising carbon dioxide CO₂ and a fifth gas stream 26 essentially comprising dihydrogen H₂.

The fifth gas stream 26 essentially comprising H₂ can be used as it is at the site of installation of the system according to the invention, for synthesis of hydrocarbons for example, and/or molecular hydrogenation, and/or production of electricity, in a fuel cell for example, and/or any industrial process using this gas. It can also be conditioned and/or liquefied in situ for storage in a tank 27 prior to subsequent use.

At least some of the fourth gas stream 25 essentially comprising CO₂ is intended to be returned to reactor 10 to be recycled and reduced to CO, as described above. At least some of the fourth gas stream 25 therefore makes up the first gaseous effluent 11. In this way the reaction cycle is closed. The ratio of the energy available, by the synthesis gases, i.e. the first and the second gas streams, to the energy potential of the solid fuel is maximum.

Some of the fourth gas stream 25 essentially comprising CO₂ can be liquefied for storage, while awaiting use, in a tank 28 and/or can be put in a buffer reservoir in the gaseous state, for regulating its usage.

The H₂ and CO molecules can thus be produced separately, in the amounts required for use, at equal or different temperatures. They can be used together, in a catalytic synthesis, or can be used separately, such as both simultaneously in different applications.

In the case of direct use in a power cogeneration system with very high efficiency—fuel cells, combined-cycle gas turbines—the first and the second gas streams can be used without molecular separation after cooling in heat exchangers E1 and E2. The transfer of the calorific value of the solid fuel to the calorific value of the synthesized gas, H₂ and CO, is maximum. Only the heat losses, which depends on the insulation employed for the enclosure E and the peripheral equipment, has to be deducted. It will then be the characteristics and qualities of the equipment using these gas streams 12 and 22 that will define the overall efficiency of the energy conversion.

The solid residues R from each of the reactors 10 and 20 are recovered and removed from reactors 10 and 20.

If H₂ is used as it is at the site of installation of the system, for synthesis of hydrocarbons for example, or molecular hydrogenation, or any industrial process using this gas, it will be desirable to use a chemical or membrane separator 25, which will make it possible for H₂ and CO₂ to be managed separately. This equipment is known and generally available.

If H₂ is intended to be stored in tank 27, partly or wholly, the current methods are cryogenic systems. Taking into account the temperature/pressure of liquefaction of H₂, the CO₂ will be liquefied naturally during the procedure, and the separation is therefore effective.

The system according to the invention also comprises at least one catalysis module 30 defined according to the choice of hydrocarbon molecules HC to be produced from the H₂ and CO obtained. This catalysis module can comprise catalysers, synthesizers, reformers, or any other system or device known and currently used by the chemical and petrochemical industry. Advantageously, the invention makes it possible to produce H₂ and

CO separately and in desired amounts. Provision of the system for catalysis and reforming is therefore based on the molecule to be obtained—synthesis of all liquid and gaseous hydrocarbons HC is possible, and is determined by the choice of synthesis module 30. Advantageously according to the invention, all types of systems for gaseous and liquid synthesis can be combined with the production of the two molecules H₂ and CO. These systems can be housed together so that they are fed simultaneously. Synthesis can thus be multiple, with simultaneous production of gas and liquid fuel, as well as automotive fuel, with a maximum efficiency of conversion, relative to the energy initially contained in the reactive biomass and/or solid fuel.

The invention here offers two independent, concomitant and simultaneous reactions in a common enclosure E comprising two communicating reactors 10 and 20 with different actions.

We shall now describe the enclosure E, by referring to FIG. 2. The enclosure E comprises the first reactor 10 for reduction of the CO₂ present in the first gaseous effluent 11 and the reactor 20 for reduction of the H₂O present in the second gaseous effluent 21.

The first reactor 10 comprises a first layer of reactive material 101 supported by a first grate 102. Grate 102 is permeable to the reaction gases and can be cooled or not. The layer of reactive material can also be called “first thermal base”. It is composed of solid fuel in oxycombustion, preferably from plant biomass B, fed onto the grate by a feed opening 103 in the form of a chute. The biomass B can be of the size of forestry sheets or of chips/shreddings from timber products, it can be shavings and/or sawdust and/or any plant matter agglomerated into granules, briquettes, sticks, etc. It can also be silvicultural and/or agricultural biomass in the anhydrous or roasted state or also densified to high carbon concentration and sized in cylindrical shape.

In certain cases and for certain applications this solid fuel can be charcoal, peat, lignite, etc.

The biomass B present on grate 102 is in oxycombustion. This oxycombustion is made possible by injection of a supporter of combustion, preferably O₂ injected into the middle of the thermal base 101 by at least one injector 104. It is the injection of O₂ that makes it possible to organize specific strata through the thickness of the first thermal base 101. The injection of O₂ is required for oxidizing the middle portion (stratum) of the first thermal base in order to generate the thermal energy necessary for all of the reactions taking place in the first thermal base. The top part of the thermal base is defined by the continuous supply of fuel B; this zone is endothermic. The bottom part, in direct contact with grate 102, is defined by the Boudouard reaction, and is controlled with respect to temperature and molecular composition (CO₂/CO ratio). It is regulated by controlling the flow rate of O₂ injected, monitoring for absence of CO₂ (the gas stream is composed essentially of CO) and supply of fuel.

Reactor 20 comprises a layer of reactive material 201 comprising high-temperature carbon components. This layer 201 can also be called the second thermal base. It is supported by a second grate 202 which can be cooled or not. The temperature of the thermal base 201 can be regulated by injection of the supporter of combustion O₂ by at least one injector 204 arranged just above the thermal base 201.

The two reactors 10 and 20 are separated by a wall 203 that has a communicating opening C through which reactors 10 and 20 are in communication.

The first grate 102 supporting the first thermal base 101 is inclined appreciably towards the second grate 202 supporting the second thermal base 201. The end of grate 102 closest to grate 202 is arranged at the level of the communicating opening C. The slope of grate 102 and the controlled oxycombustion make the middle strata of the first thermal base 101 unstable, and the ignited materials move downwards under the action of gravity. The high-temperature solid carbon particles, live embers from the thermal base 101, flow by gravity onto grate 202 through opening C to form the second thermal base 201. Grate 202 of reactor 20 receives the live embers of solid fuel from the thermal base 101 of reactor 10 which flowed by gravity through opening C. These materials, which originate from the solid biomass fuel in oxycombustion forming the first thermal base 101, are partly consumed by the oxycombustion and reduced to the state of pure carbon. The temperature of these carbon particles makes these carbon components very reactive redox components. The live embers thus flow naturally through the communication C, until the load of reactive carbon, on grate 202, covers the full height of the communicating opening C. It is the filling-up of the height of the second thermal base 201 that controls the flow of the live embers originating from the first thermal base 101.

Reactor 10 further comprises an opening for admission 105 of the first gaseous effluent 11, comprising the CO₂ to be reduced in its top part. As described above, the first gaseous effluent originates at least partly from the recycling of the fourth gas stream. The CO₂ present in the first gaseous effluent 11 is added to the CO₂ from the oxycombustion of the stratum of solid fuel. At least some of the CO₂ present in the first effluent can also come from an industrial installation external to the system according to the invention. Thus, the life cycle of the carbon that it contains can be prolonged, and its contribution to the greenhouse effect can be cut back. A varying proportion of this atmospheric pollutant can be recycled in the system according to the invention, and the CO resulting from the reduction of the CO₂ on passing through the first thermal base can be reduced in a special catalyser where it will react according to the reaction demonstrated by the physicist Boudouard: 2CO, in the presence of nickel, exchange one 0 atom for one CO. This reaction is exothermic by 172 kJ/mol and is in equilibrium at around 400° C., and this exothermic effect can be recycled in the method, i.e. 2CO→C+CO₂+172 kJ/mol. Thus, by recycling industrial CO₂, which otherwise would contribute to the greenhouse effect, the life cycle of the carbon can be extended by regenerating the native carbon components, to virgin materials, structured or not, which enter the industrial cycle, replacing fossil carbon.

The CO₂ present in the first gas stream decomposes on passing through the first thermal base comprising high-temperature carbon components. Thus, downstream of the thermal base, the first gas stream 12 is obtained, essentially comprising CO. The first gas stream 12 is discharged from reactor 10 via a discharge opening 106 located below the first grate 102. A pipeline connected to this discharge opening 106 is maintained at negative pressure by an extraction system, which provides a constant negative pressure in the zone of reactor 10. The solid residues R from the first thermal base 101, such as ash, are discharged by gravity through a discharge opening 107 provided in the bottom of the first reactor 10.

As was described above, the second thermal base 201 is supplied with solid reagent through the communicating opening C between the two reactors 10 and 20, which permits the flow of high-temperature carbon, red-hot carbon, originating from the first thermal base 101. The saturation of the second thermal base 201 is determined by the upper lip of the communicating opening C. The material making up this second thermal base 201 has powerful reducing properties, and its purpose is to deoxidize the steam to produce hydrogen and CO₂.

The top layer of the second thermal base 201, fed continuously by the first thermal base 101, is at the temperature of the thermal base 101. This top layer/stratum is traversed by the superheated steam H₂O contained in the second gaseous effluent 21, admitted into reactor 20 through an admission opening 205, located in the top part of the reactor upstream of the second thermal base 201. Some of this steam H₂O, superheated to its deoxidation temperature, will be deoxidized as it passes through the top stratum of the second thermal base 201. The deoxidation reaction

H₂O+C→H₂+CO

is endothermic. The 131 kJ/mol is supplied by the heat capacity of the top stratum of the second thermal base 201. The reaction temperature, at the level of this stratum, must be above 800° C., and if the first deoxidation reaction of H₂O risks lowering the temperature of this layer to below this threshold, O₂ injection 204 makes it possible to maintain the optimum reaction temperature.

The bottom layer of the second thermal base 201, in direct contact with the second grate 202 of the second reactor 20, provides the second “CO Shift” reaction defined by the formula

H₂O+CO→H₂+CO₂

This reaction is exothermic, by 41 kJ/mol. The thermal energy released can be contained by providing a double partition, at the level of this bottom layer, in which a heat-transfer fluid absorbs this thermal energy. The heat-transfer fluid can be water, which is then used in exchangers E1 and E2 described above. The “CO Shift” reaction proceeds downstream of grate 202 and into exchanger E2, where the exothermic effect of the reaction is dissipated to the heat-transfer fluid of the latter.

Downstream of the second grate, the second gas stream 22 is obtained, essentially comprising H₂ and CO₂. Reactor 20 further comprises a discharge opening 206 for discharging the second stream 22 from reactor 20. This discharge opening 206 is connected to a pipeline that is maintained at negative pressure by an extraction system, which controls and maintains a constant negative pressure in reactor 20.

The solid residues R from the second thermal base 201, such as ash, are discharged by gravity through a discharge opening 207 provided in the bottom of the second reactor 20.

The walls of enclosure E are configured so as to be temperature-controlled, and regulated by conventional thermal means, with external insulation of the enclosure to limit the thermal losses.

The walls of enclosure E can have an internal space, into which a heat-transfer fluid can be sprayed so as to cool these walls and recover thermal energy. Advantageously, the second gas stream 21 can accumulate additional heat capacity in this space.

Combustion in the two reactors 10 and 20 is preferably inverted, the gaseous effluents and the gas streams having a descending direction of movement in contrast to a thermal flow by gravity, whose natural direction is ascending. The gas system is therefore forced by mechanical extraction, not shown, which maintains the two reactors 10 and 20 at negative pressure. The arrangement of the flows can nevertheless be conventional, ascending in both reactors 10 and 20, or differentiated: ascending flow in one of the reactors and descending flow in the other.

The system is thus suitable for at least two independent, concomitant and simultaneous reactions. The reaction in reactor 10 thus has a triple effect:
production of the thermal energy needed by the system, by complete oxycombustion of at least some of the solid fuel,
production of reagent (red-hot carbon at very high temperature) to permit the reaction hereunder and to feed reactor 2 with reagent,
production of carbon monoxide CO, by the oxidation reaction: C+O₂→CO₂ followed by the so-called Boudouard reaction: CO₂+C→2 CO

The second thermal base 201 of reactor 2 is thus composed of red-hot carbon, which has the property of being “redox”. Every oxidized element and molecule that passes through it will be deoxidized, generating at least carbon monoxide CO. The system is then ready for the reduction of polluting molecules such as: SOx, NOx, furans and dioxins, etc., and more particularly the greenhouse gas CO₂, by prolonging its life cycle by converting it to CO, which is a commonly used industrial gas.

According to the invention, the reaction in question is more particularly deoxidation, in this reactor 20, of steam H₂O to dihydrogen H₂, which is one of the two components of hydrocarbon molecules.

The reaction in this reactor 2 takes place in two stages:

1. C+H₂O→CO+H₂

2. “CO Shift”: CO+H₂O→CO₂+H₂

The first stage of this reaction is endothermic: by 131 kJ/mol, and the second stage is exothermic: by 41 kJ/mol, therefore the overall reaction is endothermic and requires a heat input of 90 kJ/mol, with which it is supplied by the oxycombustion of at least some of the basic plant biomass, in reactor 10. A system for supplying oxygen is advantageously provided at the level of reactor 20 to make up for any energy deficit.

According to the invention we therefore have two different gases leaving reactors 10 and 20:
from reactor 1 we obtain CO by the Boudouard reaction, and
from reactor 2 we obtain CO₂ and H₂ in respective molar proportions close to ⅓, ⅔.

These gases are at very high temperature, greater than or equal to 1000° C. at the outlet of reactor 10 and about 800° C. at the outlet of reactor 20, and they have a substantial heat capacity. These gases must be cooled in order to be purified and separated (notably H₂ from CO₂) and they are therefore passed, each stream separately, through a water/gas heat exchanger. The water fed into the exchanger is liquid, this makes it possible to determine the appropriate, constant temperature of the gas stream that will exchange its heat with this water. As exchange proceeds, the water is vaporized and the temperature of the steam rises (600/800° C.), and it is this “superheated” steam at high temperature that will be fed into the hearth 20, as second gaseous effluent, to be deoxidized there in reactor 20. In doing so, a large part of the thermal energy employed in the reactions is recovered and recycled.

The gases are thus cooled to the temperatures of use for their filtration/purification (aerosols transported, carbon-containing materials, residual H₂O etc.) and their separation, before being brought together in a dedicated catalytic system for the defined formulation of hydrocarbon compounds.

The CO₂ produced by the combustion and reactions of the solid source fuel is preferably, according to the invention, of plant origin (it is neutral with respect to the greenhouse gas problem since the vegetation to be renewed absorbs its equivalent CO₂ while growing back). Its liquefaction (for industrial use), its sequestration, and its conversion to CO (as a substitute for fossil fuels) make it possible to reduce, by the same amount, the part of the industrial CO₂ of fossil origin discharged into the atmosphere. Its recycling by the system according to the invention maximizes the efficiency of conversion of the “source” energy of the initial solid fuel, to energy made available by the synthesized hydrocarbon compounds.

The enclosure E is designed so as to satisfy the temperature requirements of reactors 10 and 20. It can be considered that the grates 102 and 202 of each of the reactors 10 and 20 divide each of the reactors into two zones: a zone upstream of the grate and a zone downstream of the grate. Each of the reactors receives the inlet pipe of the gaseous effluent to be treated in the upstream zone and the outlet pipe of the resultant gas stream in the downstream zone. The upstream zones also comprise the O₂ injectors. The upstream zone of reactor 10 further comprises the admission opening 103 for the biomass B. The downstream zones of reactors 10 and 20 comprise the openings for extraction, respectively 106 and 206, of the first and second gas streams 12 and 22 obtained and the openings for removal, respectively 107 and 207, of the residues R.

The enclosure according to the invention can be called the “Plant Carbon Reactor”.

Of course, the invention is not limited to the example of application described above.

1-28. (canceled)

29. A method for the treatment of a first gaseous effluent essentially comprising carbon dioxide and of a second gaseous effluent essentially comprising steam, said method comprising the following stages:
generation of a first gas stream comprising carbon monoxide by passing said first gaseous effluent through a first layer of redox reactive material comprising high-temperature carbon components; and
generation of a second gas stream essentially comprising dihydrogen by passing said second gaseous effluent through a second redox layer of reactive material comprising high-temperature carbon components; and
utilization of at least one of the first and second gas streams;
at least some of said second redox layer being provided by transfer or recovery of at least some of the high-temperature carbon components of the first layer.

30. The method according to claim 29, characterized in that it comprises, during passage of the second gaseous effluent, containing essentially steam, through the second layer containing high-temperature carbon components:
reduction of the molecules of steam in the presence of said high-temperature carbon components, said reduction producing molecules of dihydrogen ; and
oxidation of at least some of said high-temperature carbon components, said oxidation producing molecules of carbon dioxide;
the second gas stream essentially comprising dihydrogen and carbon dioxide.

31. The method according to claim 30, characterized in that it comprises, during passage of the first gaseous effluent, containing essentially carbon dioxide, through the first layer containing high-temperature carbon components:
reduction of the molecules of carbon dioxide in the presence of said high-temperature carbon components, said reduction producing molecules of carbon monoxide, and
oxidation of at least some of said high-temperature carbon components, said oxidation producing molecules of carbon monoxide.

32. The method according to claim 29, characterized in that it comprises heat exchange of at least one of the first and second gas streams with a heat-transfer stream, said gas stream giving up at least some of its thermal energy to said heat-transfer stream.

33. The method according to claim 32, characterized in that the heat-transfer stream comprises liquid water, the heat exchange producing a third gas stream comprising high-temperature steam, at least some of the steam contained in the second gaseous effluent coming from said third gas stream.

34. The method according to claim 30, characterized in that it comprises separation of the carbon dioxide contained in the second gas stream, said separation supplying a fourth gas stream essentially comprising carbon dioxide, at least some of the carbon dioxide present in the first gaseous effluent coming from said fourth gas stream.

35. The method according to claim 29, characterized in that at least some of the first redox layer is produced by combustion, in the presence of a supporter of combustion, of a fuel comprising carbon components under substoichiometric conditions, said solid fuel comprising plant biomass, said supporter of combustion being injected into the middle of the first layer.

36. The method according to claim 29, characterized in that the temperature of the first layer is greater than or equal to 1000° C., and the temperature of the second layer is between 700 and 1000° C.

37. The method according to claim 29, characterized in that it comprises separation of the molecules of dihydrogen present in the second gas stream, said separation supplying a fifth gas stream essentially comprising dihydrogen.

38. The method according to claim 29, characterized in that it further comprises combustion of combustible particles present in at least one of the first and second gaseous effluents during passage of said gaseous effluent through the first layer and/or the second layer.

39. A system for recycling a first gaseous effluent essentially comprising carbon dioxide and a second gaseous effluent essentially comprising steam, said system comprising an enclosure comprising:
a first reactor comprising a first grate supporting a first redox layer of reactive material comprising high-temperature carbon components, said first layer being traversed by said first gaseous effluent supplying a first gas stream comprising carbon monoxide;
a second reactor comprising a second grate supporting a second redox layer of reactive material comprising high-temperature carbon components, said second layer being traversed by said second gaseous effluent supplying a second gas stream comprising dihydrogen; and
openings for extraction permitting separate extraction of said first and second gas streams from said enclosure,
said system further comprising means for utilization of at least one of said first and second gas streams.

40. The system according to claim 39, characterized in that it comprises a communicating opening through which the first and second reactors communicate with one another so that at least some of the high-temperature carbon components of the first layer pass from the first reactor to the second reactor through said communicating opening to form at least some of the second layer, the first grate supporting the first layer being located higher than the second grate supporting the second layer, said first grate being inclined appreciably towards the second grate, the lowest end of the first grate being located at the level of said communicating opening, so that at least some of the high-temperature carbon components of the first layer flow from the first reactor to the second reactor to form the second layer.

41. The system according to claim 39, characterized in that the first and second grates are permeable to the first or second gas stream, each of said grates separating the reactor comprising said grate into a first area and a second area, said first area being located above said grate and comprising a feed opening for the gaseous effluent and said second area being located below said grate and comprising an opening for extraction of the gas stream.

42. The system according to claim 39, characterized in that the first reactor comprises a feed opening, on the first grate, for a fuel comprising carbon components, the first layer being produced by combustion of said fuel under substoichiometric conditions in the presence of a supporter of combustion under substoichiometric conditions.

43. The system according to claim 39, characterized in that each of the first and second reactors comprises means for injection of a supporter of combustion into said reactor.

44. The system according to claim 39, characterized in that it comprises at least one heat exchanger providing heat exchange of at least one of said first and second streams with a heat-transfer fluid, said heat-transfer fluid comprising water, said heat exchanger supplying a third gas stream essentially comprising high-temperature steam, said system moreover comprising a circuit for conveying at least some of the third gas stream into the second reactor.

45. The system according to claim 29, characterized in that it comprises means for separating the various gaseous compounds of the second gas stream, said second gas stream comprising dihydrogen and carbon dioxide obtained by oxidation-reduction of steam in the presence of high-temperature carbon components, said separation supplying a fourth gas stream essentially comprising carbon dioxide and a fifth gas stream essentially comprising dihydrogen.

46. The system according to claim 45, characterized in that it comprises a circuit for conveying at least some of the fourth stream into the first reactor.
